(19) United States
(12) Patent Application Publication
(10) Pub. No.: US 2011/0038999 A1
(43) Pub. Date: Feb. 17, 2011

(54) Cookware with reservoir

(76) Inventors: Jeffrey Payne Lara, Navasota, TX (US); James Emmett Moody, Anderson, TX (US)

Correspondence Address: THE MATTHEWS FIRM, 2000 BERING DRIVE, SUITE 700, HOUSTON, TX, 77057, US

(21) Appl. No.: 12/583,051

(22) Filed: Aug. 13, 2009

(51) Int. Cl. A47J 37/10; A23L 1/01

(52) U.S. Cl. 426/438; 99/425; 426/509; 426/510; 426/523

(57) ABSTRACT

An item of cookware having a reservoir for containing a cooking liquid is described herein. The cookware includes an outer surface sized for engagement with a cooking device and retention of one or more food items. A reservoir is disposed within the outer surface in a position for receiving heat from the cooking device. The reservoir is sized to contain one or more food items and a quantity of cooking oil or another liquid sufficient to cook the food items. The outer surface is sloped toward the reservoir, such that oil and other liquids from cooked food items placed on the outer surface drains into the reservoir for reuse, providing both health and economic benefits. The outer surface also receives heat from the cooking device sufficient to warm food items not currently being cooked.

### FIELD

The present invention relates, generally, to an item of cookware having a reservoir for holding cooking oil or other cooking liquids, during use, and more specifically, to disc-shaped item of cookware usable with an outdoor gas cooker or similar cooking device.

### BACKGROUND

A conventional wok is a round-bottomed cooking vessel, originating in China, usable for a wide variety of cooking applications, most notably frying and stir-frying. Though woks are available in a variety of shapes and sizes, woks are generally large, broad, concave vessels. During typical use, a significant quantity of oil must be placed in the wok to coat the entirety of the cooking surface while the wok is heated. Food items are then placed in the heated oil. The shape and material of the wok enables the oil to reach a high temperature, imparting a unique flavor and aroma characteristic to wok cooking. To fry the food items, a sufficient quantity of oil must be used to cover the food items. To stir-fry the food items, enough oil must be used to coat both the cooking surface of the wok and any cooking food items, while the food items are stirred, flipped, and/or rotated to ensure even cooking. Regardless of the method of cooking desired, a large quantity of cooking oil is required when using a conventional wok.

Both health and economic factors have strongly influenced modern cooking techniques, generating a strong desire among consumers to consume foods having a lower fat content and to utilize healthier cooking oils, such as olive oil, while avoiding significant or wasteful expense. As overall health consciousness throughout the world has increased, the cost of olive oil and other healthier cooking oils has increased tremendously. The higher cost of cooking oils is further accentuated during times of economic instability. These factors cause conventional wok cooking to be somewhat undesirable due to the large quantity of cooking oil required to prepare a meal. The majority of the oil used to cook is wasted, and foods prepared using a conventional wok are often saturated and/or covered with excess oil.

To compensate somewhat for these undesirable factors, smaller woks can be used, which require less oil, however, these smaller items of cookware are unable to contain large numbers of food items simultaneously and are often prone to allowing hot oil to splatter over their comparatively short edges during cooking. Flat-bottom woks have also been used to reduce the quantity of cooking oil required by providing a broad, shallow, flat cooking surface, similar to a conventional skillet. These flat-bottom woks are also advantageously usable with indoor stoves without requiring a wok ring or similar mounting device. However, a flat-bottom wok does not provide the concentrated heating of a pool of oil for which conventional concave woks have become known, resulting in slower cooking and less authentic flavors.

A need exists for an item of cookware that utilizes less cooking oil than conventional woks and other items of cookware, thereby conserving costs and avoiding waste, while retaining a shape conducive to concentrating heat and accelerating the cooking process.

A need also exists for an item of cookware able to perform a large variety of cooking techniques, such as frying, searing, boiling, and steaming, using oil and other liquids, such as water, the latter of which provide improved health benefits through preserving vitamins and natural nutrients within many foods.

A further need exists for an item of cookware that enables cooking oil to be drained and recovered from cooked food items, thus reducing fat consumption, avoiding waste by allowing the recovered oil to be reused, and enhancing the flavor of other food items cooked subsequently.

A need also exists for an item of cookware sized to contain multiple food items simultaneously, that is usable to warm and maintain the temperature of food items not currently being cooked.

The present invention meets these needs.

### SUMMARY

The present invention relates, generally, to an item of cookware usable with a variety of cooking devices, including outdoor gas cookers. In a preferred embodiment of the invention, the cookware includes an outer surface having a reservoir for containing cooking oil disposed within. The exterior of the outer surface is sized for engagement with a cooking device, while the interior of the outer surface is sized and adapted for retention of food items. The interior of the reservoir is sized to contain one or more of the food items during cooking and a quantity of oil or another liquid sufficient to cook the one or more food items. The exterior of the reservoir is configured to receive heat from a cooking device sufficient to cook food items within the reservoir. The interior of outer surface of the cookware is sloped slightly toward the reservoir, such that cooking oil or other liquids that drain from items placed on the outer surface flow into the reservoir and are recovered for reuse.

To facilitate maintaining the cookware in a generally level orientation before or during use, a stand can be provided, the stand having a top member sized to at least partially contain and engage the exterior of the reservoir, and a bottom member configured to rest on a generally horizontal surface, such that the associated cookware is retained in a generally horizontal orientation. The stand can be placed over a gas burner or warmer, or a similar heat source to cook or warm food items, or the stand can be placed without a heat source, such as when using the present cookware to serve or otherwise store food items before or after cooking.

In use, the cookware can be engaged with a cooking device, such as an outdoor gas cooker, such that heat from the cooking device is directly applied to the underside of the reservoir and indirectly applied to the underside of the outer surface. When the oil within the reservoir has been sufficiently heated, food items can be placed into the reservoir and cooked in a searing, frying, and/or sautéing manner, then removed after cooking. If the reservoir contains water rather than oil, food items can be placed in the reservoir and boiled, or a cover can be placed over the reservoir and at least a portion of the outer surface to enable steaming of food items proximate to the reservoir.

The cooked food items can be placed on the outer surface, where undesired excess cooking oil and other liquids drain from the food items. The used cooking liquids flow down the slope of the outer surface into the reservoir, where they can be used to cook additional food items, which beneficially receive enhanced flavor from these liquids. The heat provided to the underside of outer surface by the cooking device enables warming of food items not currently being cooked, maintaining the food items at a desirable temperature until removed from the cookware. Additionally, the small size of the reservoir greatly reduces the amount of cooking oil required to prepare a meal, while concentrating the heat from the cooking device, thereby accelerating the cooking process.

In an embodiment of the invention, a perforated insert can be placed over at least a portion of the outer surface, and spaced apart from the outer surface to maintain a distance therebetween, such as through use of standing legs or similar spacing members. The perforated insert can maintain food items away from the outer surface when less heat than what would be provided through direct contact with the outer surface is desired, while permitting oil and other cooking liquids to drain from retained food items through the perforated insert to the outer surface, where the cooking liquids flow into the reservoir.

While the size and shape of the present cookware can vary depending on the quantity of food items to be prepared and/or cooked simultaneously, and the size and type of cooking device to be engaged with the cookware, in an embodiment of the invention, the present cookware can be a round, generally disc-shaped apparatus. One embodiment of the invention includes an outer surface approximately 24 inches in diameter, having a hemispherical reservoir disposed at its center. In this embodiment of the invention, the reservoir can have a diameter of about 6 inches and a depth of about 1.5 inches, thus requiring a comparatively small amount of cooking oil compared to similarly sized items of cookware.

The reservoir can be integral with the outer surface, or in an embodiment of the invention, the reservoir can be removable to facilitate ease of cleaning, emptying, and refilling. In a further embodiment of the invention, the cookware can include a removable meshed insert, sized for at least partial entry into the reservoir. The insert can be sized to contain one or more food items within the reservoir to facilitate removal of the food items from cooking liquids without requiring tongs or a similar utensil, through removal of the insert.

In an embodiment of the invention, a raised edge or lip can be disposed about the perimeter of the outer surface for preventing food items from falling when cookware is carried. The rim can be a sidewall of any height or thickness, such as a thin barrier approximately 1.5 inches in height. The raised edge and/or a portion of the outer surface can include an indentation for use pouring oil or other liquids from the cookware after use or draining a desired amount of liquid from the cookware when less is needed. The raised edge and/or the outer surface can have one or more handles affixed thereto to facilitate carrying of the cookware and/or removal of liquid.

In a further embodiment of the invention, one or more raised lips can be disposed on the outer surface, encircling and proximate to the perimeter of the reservoir to prevent food items placed on the sloped outer surface from inadvertently sliding into the reservoir. The raised lip can include one or more gaps to enable oil or other cooking liquids from the outer surface to flow into the reservoir for recovery unimpeded by the lip.

All parts of the present cookware, including the outer surface, the reservoir, a raised edge, if present, any handles, and/or a meshed insert or cover, if used, can be made from any material able to conduct heat from a cooking device to liquid and food items disposed within the reservoir and atop the interior of the outer surface, that is sufficiently light to enable transport. In an embodiment of the invention, the present item of cookware can be made from aluminum, steel, or a similar metal. In a further embodiment of the invention, differing portions of the cookware can be made from different metals. For example, the outer surface and reservoir could be made from a highly conductive metal to promote heat transfer, while handles attached to the cookware could be made from a less conductive metal, a heat resistant plastic, rubber, one or more polymers, or other less conductive materials to enable a user to transport the cookware when hot.

The present invention thereby provides an item of cookware and methods of use that are usable with a large variety of cooking devices, including outdoor gas cookers, and which require a relatively small quantity of cooking oil when compared with other items of cookware of similar size and function, thereby conserving costs and enabling economic use of healthier cooking oils. The small size and conducive shape of the reservoir accelerates the cooking process, saving time, while enabling rapid achievement of high temperatures suitable for providing qualities to food items characteristic of wok-style cooking. The sloped outer surface provides multiple benefits by warming food items not currently being cooked, and by enabling recovery of liquid from cooked food items, which conserves oil, reduces the quantity of oil eaten, and provides beneficial flavors to subsequent food items to be cooked.

### BRIEF DESCRIPTION OF THE DRAWINGS

In the detailed description of the embodiments of the invention presented below, reference is made to the accompanying drawings, in which:

FIG. 1 depicts an embodiment of the present item of cookware.

FIG. 2A depicts a top view of an alternate embodiment of the item of cookware.

FIG. 2B depicts an elevated view of the item of cookware depicted in FIG. 2A.

FIG. 3 depicts an embodiment of the present item of cookware and a stand usable to engage the item of cookware.

Embodiments of the present invention are detailed below with reference to the listed Figures.

### DETAILED DESCRIPTION OF THE EMBODIMENTS

Before explaining the described and depicted embodiments of the invention in detail, it is to be understood that the present invention is not limited to the particular embodiments described and depicted and that the present invention can be practiced or carried out in various ways.

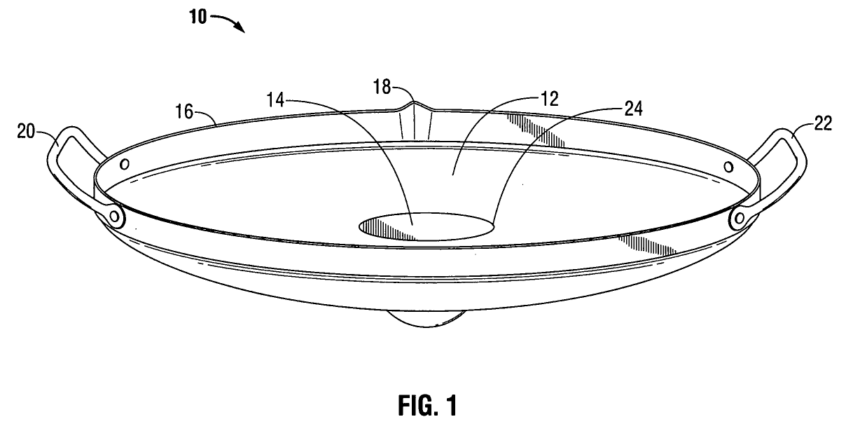

Referring now to FIG. 1, an embodiment of the present item of cookware is shown.

The depicted cookware (10) is shown as a disc-shaped article usable to cook food items using heated oil, water, or other liquids. The cookware (10) includes an outer surface (12), concentrically disposed about a central reservoir (14). In the depicted embodiment of the invention, the outer surface (12) is shown having a generally circular shape, with a diameter of about 24 inches, while the reservoir has a generally hemispheric shape with a diameter of about 6 inches and a depth of about 1.5 inches. The interior of the outer surface (12) is sloped at a slight angle toward the reservoir (14), for enabling liquids, such as cooking oil, to flow along the outer surface (12) to the reservoir (14). The angle of the outer surface (12) can vary depending on the intended use of the cookware (10), however the angle should be small enough to avoid inadvertent slipping of food items into the reservoir (14). Only a slight angle, as small as 1-5 degrees, is necessary to enable cooking oil to flow to the reservoir (14), though greater angles are also usable.

While FIG. 1 depicts the cookware (10) having a disc shape with a central reservoir (14), it should be understood that the cookware (10) can have any size or shape, with a reservoir disposed within any portion of the outer surface, such that at least a portion of the outer surface is angled to flow liquids toward the reservoir.

The reservoir (14) is shown having a raised lip (24) disposed about its perimeter for preventing food items placed on the outer surface (12) from unintentionally falling into the reservoir (14). The raised lip (24) can have any height, width, or configuration, and in an embodiment of the invention, the raised lip (24) can be generally short and rounded for enabling cooking oil and other liquids to flow over the raised lip (24) into the reservoir (14) while inhibiting the movement of food items. In an alternate embodiment of the invention, the raised lip (24) can include one or more gaps for permitting the flow of liquid, the gaps being sufficiently small in size and spaced sufficiently to prevent passage of food items therethrough.

A raised edge (16) is shown disposed about the perimeter of the outer surface (12). While the raised edge (16) can have any configuration or dimensions, FIG. 1 depicts the raised edge (16) as a thin sidewall having a height of about 1.5 inches. The raised edge (16) includes an indentation (18), usable as a pouring spigot to drain oil or other liquids from the cookware (10). In embodiments of the present cookware lacking a raised edge, a similar indentation can be formed at the edge of the outer surface (12).

FIG. 1 further depicts a first handle (20) and a second handle (22) secured to the raised edge (16) to enable carrying of the cookware (10) to and from a cooking device, to handle the cookware (10) for cleaning, to pour/drain liquids using the indentation (18), and other similar uses.

In operation, one or more food items to be cooked can be placed along the interior of the outer surface (12) of the cookware (10). The cookware (10) can then be carried to a cooking device, such as an outdoor gas cooker, using the handles (20, 22), and placed atop or otherwise in engagement with the cooking device, such that direct heat can be applied to the underside of the reservoir (14) of the cookware (10), and indirect heat can be applied to the underside of the outer surface (12). During transport of the cookware (10) and food items, the raised edge (16) can prevent the loss of food items from the outer surface (12) should the cookware (10) be inadvertently tilted.

Cooking oil, such as olive oil or another type of usable cooking oil, is then provided to the reservoir (14), and the cookware (10) and oil are heated using the cooking device. One or more food items can be sequentially or simultaneously placed in the reservoir (14) with the oil, such that the food items are fried and/or seared. The food items can then be removed from the reservoir (14) and placed along the outer surface (12), such as by using tongs or a similar implement, or by using a meshed insert sized for at least partial insertion into the reservoir (14). Alternatively, water could be provided to the reservoir (14), heated, and food items placed within the reservoir can be boiled. In a further embodiment of the invention, water could be provided to the reservoir (14), and selected food items placed on the outer surface (12) proximate to the reservoir. A cover could be engaged over the reservoir (14) and at least a portion of the outer surface (12) proximate to the reservoir (14), such that the as the water within the reservoir (14) boils, the food items proximate to the reservoir (14) are steamed.

Independent of the method of cooking utilized, excess oil or other liquids from the food items placed on the outer surface (12) then drains from the food items and flows down the sloped outer surface (12) into the reservoir (14) for use cooking subsequent food items. While subsequent food items are cooked in the reservoir (14), the indirect heat applied to the outer surface (12) warms and maintains the temperature of the cooked food items.

Once all of the food items have been cooked and use of the cookware (10) is complete, the food items can be removed from the outer surface (12), and oil or other liquids from the reservoir (14) can be removed by lifting the cookware (10) using the handles (20, 22), and pouring the liquids from the cookware (10) via the indentation (18). In an alternate embodiment of the invention, the reservoir (14) can be removable from the outer surface (12) to facilitate emptying and cleaning of the reservoir (14).

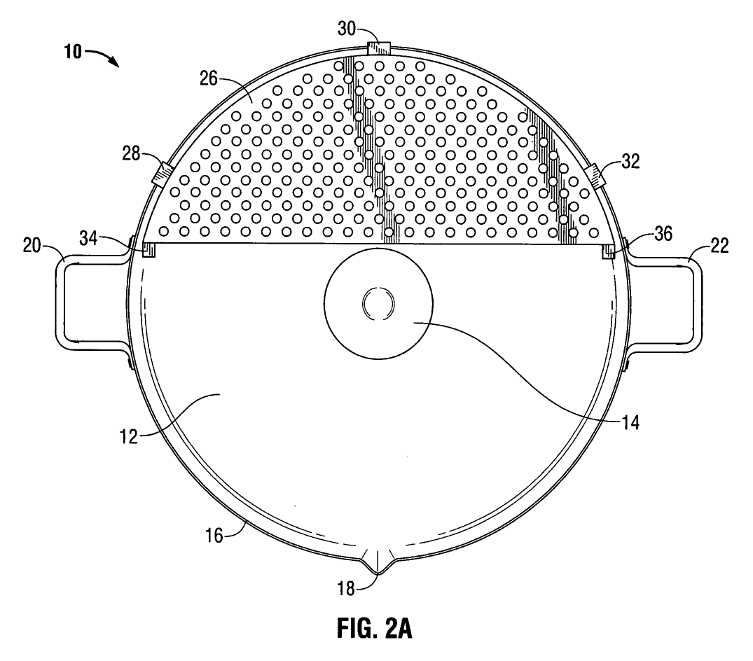

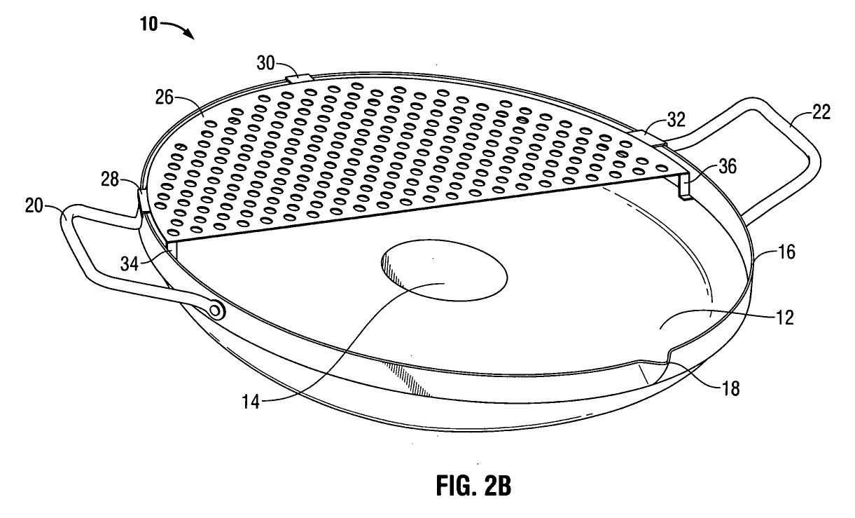

Referring now to FIGS. 2A and 2B, an alternate embodiment of the present cookware (10) is depicted, having an outer surface (12) with a reservoir (14) disposed therein, a raised edge (16) with an indentation (18), and two handles (20, 22), as described previously.

The depicted embodiment is also shown having a perforated insert (26) disposed over a portion of the outer surface (12), the perforated insert (26) being adapted to retain cooked food items while allowing oil and other cooking liquids to drain through the perforations on to the outer surface (12), where the recovered cooking liquids can then flow into the reservoir (14). The perforated insert (26) is depicted having a generally flat, partial circle shape, however it should be understood that an insert having any shape or configuration can be utilized.

The perforated insert (26) is shown having a first clip (28), a second clip (30), and a third clip (32) generally equidistantly disposed about the outer circumference of the perforated insert (26), each clip (28, 30, 32) sized to extend over and engage the raised edge (16), thereby securing the perforated insert (26) in place. The perforated insert (26) is also shown having a first leg (34) and a second leg (36) disposed opposite the clips (28, 30, 32), the legs (34, 36) spacing the perforated insert (26) a short distance above the outer surface (12) to facilitate drainage of cooking liquid while reducing the heat applied to retained food items, which can be desirable to prevent overcooking.

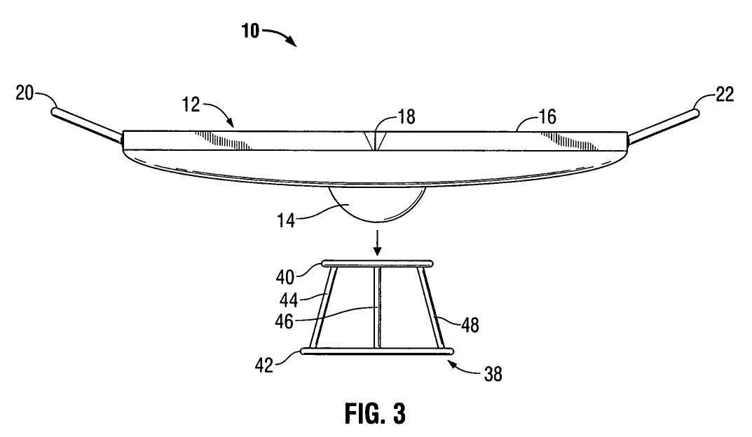

Referring now to FIG. 3, an embodiment of the present cookware (10) is shown, having an outer surface (12), reservoir (14), raised edge (16), and handles (20, 22), as described previously.

A stand (38) is also shown, the stand (38) being adapted to engage the underside of the reservoir (14) to maintain the cookware (10) in a generally level orientation. The stand (38) is depicted having an upper member (40), shown as a ring sized to receive and partially contain the reservoir (14), and a lower member (42), shown as a larger ring adapted to stabilize the stand (38) when placed in contact with a generally horizontal surface. A first vertical support (44), a second vertical support (46), and a third vertical support (48) extend between the upper member (40) and the lower member (42), the vertical supports (44, 46, 48) being generally equally spaced about the circumference of the upper and lower members (40, 42), providing the stand (38) with a generally frustroconical shape. The length of the vertical supports (44, 46, 48) can be varied, depending on the desired height of the stand (38).

The depicted stand (38) includes sufficient space within the circumference of the lower member (42) and beneath the upper member (40) to accommodate placement of a warmer, cooker, or similar heat source, enabling food items contained on the cookware (10) to be cooked or warmed. The stand (38) is also usable simply to stabilize the cookware (10) before or after transferring the cookware (10) to a heat source for preparation of food items. The stand (38) includes sufficient space within the circumference of the lower member (42) and beneath the upper member (40) to accommodate placement of a warmer, cooker, or similar heat source, enabling food items contained on the cookware (10) to be cooked or warmed. The stand (38) is also usable simply to stabilize the cookware (10) before or after transferring the cookware (10) to a heat source for preparation of food items.

It should be noted that while FIG. 3 depicts a generally frustroconical stand with ring shaped engagement and stabilizing members, stands having other shapes and configurations are also usable to engage any portion of the underside of the cookware, while simultaneously engaging a surface, to maintain the cookware in a generally level orientation.

The present item of cookware thereby enables simultaneous cooking of one or more food items while warming other food items, can be utilized to perform a variety of cooking methods, requires only a small quantity of oil to cook any number of foods, and efficiently recovers and reuses oil from cooked food items. Use of a small quantity of cooking oil in a reservoir advantageously shaped and positioned to receive heat enables an accelerated cooking process. Additional features of the present invention, such as a pouring spigot, handles, a stand, and the generally broad shape of the outer surface, enable the cookware to be used to transport multiple food items to and from a cooking device, to serve food items, and to pour oil or other liquids from the outer surface and reservoir.

While various specific embodiments of the invention have been described with emphasis, it should be understood that within the scope of the appended claims, the present invention can be practiced other than as specifically described herein.

1. An item of cookware comprising:
an outer surface comprising an interior and an exterior, wherein the exterior is sized for engagement with a cooking device and the interior is adapted for retention of at least one food item; and
a reservoir comprising a reservoir interior and a reservoir exterior, wherein the reservoir is disposed within the outer surface, wherein the reservoir is positioned within the outer surface such that the reservoir exterior receives heat from a heat source of the cooking device, wherein the reservoir interior is sized to contain at least one food item and a quantity of liquid sufficient to cook said at least one food item, and wherein the interior of outer surface is sloped to enable draining of liquid from the interior to the reservoir interior.

2. The cookware of claim 1, further comprising a raised edge disposed on a perimeter of the outer surface for preventing loss of the at least one food item from the cookware.

3. The cookware of claim 2, wherein the raised edge comprises an indentation for enabling pouring of the liquid from the cookware.

4. The cookware of claim 1, wherein the outer surface comprises an indentation for enabling pouring of the liquid from the cookware.

5. The cookware of claim 1, further comprising a raised lip disposed on a perimeter of the reservoir for preventing inadvertent entry of food items into the reservoir.

6. The cookware of claim 5, wherein the raised lip comprises at least one gap for permitting liquid to flow from the interior of the outer surface to the reservoir interior.

7. The cookware of claim 1, further comprising at least one handle in communication with the outer surface.

8. The cookware of claim 1, wherein the cooking device comprises an outdoor gas cooker.

9. The cookware of claim 1, wherein the outer surface is positioned such that the exterior receives heat from the cooking device sufficient to warm food items disposed on the interior of the outer surface, and wherein the reservoir exterior is positioned to receive heat from the cooking device sufficient to cook food items placed in the liquid within the reservoir interior.

10. The cookware of claim 1, wherein the reservoir is removable from the outer surface.

11. The cookware of claim 1, further comprising a meshed insert sized for at least partial entry into the reservoir, interior wherein the meshed insert is adapted to contain said at least one food item and facilitate simultaneous removal of the meshed insert and said at least one food item from the reservoir interior.

12. The cookware of claim 1, further comprising a cover sized for placement over the reservoir and at least a portion of the interior of the outer surface.

13. The cookware of claim 1, further comprising a perforated insert sized to cover at least a portion of the interior of the outer surface, wherein the perforated insert comprises at least one spacing member configured to retain the perforated insert a distance from the interior of the outer surface, and wherein the perforated insert is adapted to contain said at least one food item and to enable draining of liquid from said at least one food item through the perforated insert to the interior of the outer surface.

14. The cookware of claim 1, further comprising a stand, wherein the stand comprises a top member sized to at least partially contain and engage the reservoir exterior and a bottom member configured to retain the cookware at a generally horizontal orientation when placed in contact with a generally horizontal surface.

15. A method for cooking at least one food item, the method comprising the steps of:
providing an item of cookware in communication with a cooking device, wherein the item of cookware comprises:
a reservoir containing a quantity of liquid sufficient to cook said at least one food item, wherein the reservoir is positioned to receive heat from the cooking device sufficient to cook said at least one food item; and
an outer surface in communication with the reservoir, wherein the outer surface is positioned to receive heat from the cooking device sufficient to warm said at least one food item, and wherein the outer surface is sloped to enable draining of liquid from the outer surface to the reservoir;
placing said at least one food item in association the reservoir until the at least one food item has been cooked;
moving said at least one cooked food item from the reservoir to the outer surface; and
permitting liquid from said at least one cooked food item to drain from the outer surface to the reservoir.

16. The method of claim 15, further comprising the step of:
retaining said at least one food item on the outer surface to maintain the temperature of said at least one food item while placing at least one additional food item in association the reservoir for cooking.

17. The method of claim 15, wherein the step of placing said at least one food item in association the reservoir until the at least one food item has been cooked comprises frying said at least one food item in the oil, searing said at least one food item in the oil, sautéing said at least one food item, boiling said at least one food item, steaming said at least one food item, or combinations thereof.

18. The method of claim 15, wherein the cookware further comprises a meshed insert sized for at least partial entry into the reservoir, wherein the step of placing said at least one food item in association with the reservoir further comprises placing said at least one food item within the insert, and wherein the step of moving said at least one cooked food item from the reservoir comprises simultaneously removing the insert and said at least one food item from the reservoir.

19. The method of claim 15, wherein the cookware further comprises a perforated insert covering at least a portion of the outer surface, wherein the perforated insert comprises at least one spacing member configured to retain the perforated insert a distance from the outer surface, wherein the perforated insert is adapted to contain said at least one food item and to enable draining of liquid from said at least one food item through the perforated insert to the interior of the outer surface, the method further comprising the step of retaining said at least one food item on the perforated insert to maintain the temperature of said at least one food item and to permit liquid from said at least one food item to drain through the perforated insert to the outer surface.

20. A cookware apparatus comprising:
a disc-shaped cooking article; and
a reservoir engaged with the disc-shaped cooking article,
wherein at least one of the cooking article and the reservoir are configured to receive heat from a cooking device.

21. The cookware apparatus of claim 20, the apparatus further comprising a stand coupled with at least one of the disc-shaped cooking article and the reservoir.

22. The cookware apparatus of claim 21, wherein the stand is configured to accommodate placement of the cooking device underneath the at least one of the disc-shaped cooking article and the reservoir.

23. The cookware apparatus of claim 20, wherein the heat from the cooking device is directed to the underside of the reservoir.

24. The cookware apparatus of claim 20, wherein the reservoir is concentrically disposed within the center of the disc-shaped cooking article.

25. The cookware apparatus of claim 20, wherein the disc-shaped article and the reservoir are integrally formed with each other.

26. The cookware apparatus of claim 20, wherein at least one of the disc-shaped article and the reservoir are made from aluminum.

27. The cookware apparatus of claim 20, wherein the disc-shaped cooking article comprises an outer surface further comprising an interior and an exterior, wherein the exterior is sized for engagement with the cooking device and the interior is adapted for retention of at least one food item, and wherein the reservoir comprises a reservoir interior configured to contain at least one food item and a quantity of liquid sufficient to cook the at least one food item.
